(19) United States
(12) Patent Application Publication
(10) Pub. No.: US 2012/0173391 A1
(43) Pub. Date: Jul. 5, 2012

(54) MEDICATION INVENTORY MANAGEMENT

(76) Inventors: Daniel J. Korhnak, North Huntingdon, PA (US); Russ Gadagno, Harrison City, PA (US); Eric Kepes, Wexford, PA (US); Chayla Whaley, Valencia, PA (US); Douglas J. Moon, Enon Valley, PA (US)

(21) Appl. No.: 12/980,728

(22) Filed: Dec. 29, 2010

(51) Int. Cl. G06Q 10/00

(52) U.S. Cl. 705/28

(57) ABSTRACT

Systems, methods, apparatus, and computer program products are provided for medication inventory management. In one embodiment, a medication server may receive medications requests. The medication server may then assign the medication requests to one or more medication filling devices for filling based at least in part on their inventory available for filling such requests. The one or more medication filling devices can then process and fill the assigned medication requests.

### BACKGROUND

Medication requests can be filled automatically, semi-automatically, and/or manually by one or more medication filling devices. However, when a medication request is transmitted to a medication filling device to be filled, the device's medication inventory may not be adjusted until the medication request has been filled. Thus, a medication filling device may be assigned to fill medication requests, but not have sufficient inventory to fill the requests. Thus, a need exists for medication inventory management of medication filling devices to more effectively fill medication requests.

### BRIEF SUMMARY

In general, embodiments of the present invention provide systems, methods, apparatus, and computer program products for medication inventory management.

In accordance with one aspect, a method for medication inventory management is provided. In one embodiment, the method comprises (1) identifying a first medication request that identifies (a) a type of medication requested and (b) a quantity of the medication requested; (2) determining whether a first medication filling device's inventory has the quantity of the type of medication requested via the first medication request available to reserve for filling medication requests; and (3) after determining that the first medication filling device's inventory has the quantity of the type of medication requested via the first medication request available to reserve for filling medication requests, reserving, from the first medication filling device's inventory, the quantity of the type of medication requested via the first medication request.

In accordance with yet another aspect, a computer program product for medication inventory management is provided. The computer program product may comprise at least one computer-readable storage medium having computer-readable program code portions stored therein, the computer-readable program code portions comprising executable portions configured to (1) identify a first medication request that identifies (a) a type of medication requested and (b) a quantity of the medication requested; (2) determine whether a first medication filling device's inventory has the quantity of the type of medication requested via the first medication request available to reserve for filling medication requests; and (3) after determining that the first medication filling device's inventory has the quantity of the type of medication requested via the first medication request available to reserve for filling medication requests, reserve, from the first medication filling device's inventory, the quantity of the type of medication requested via the first medication request.

In accordance with yet another aspect, an apparatus comprising at least one processor and at least one memory including computer program code is provided. In one embodiment, the at least one memory and the computer program code may be configured to, with the processor, cause the apparatus to at least (1) identify a first medication request that identifies (a) a type of medication requested and (b) a quantity of the medication requested; (2) determine whether a first medication filling device's inventory has the quantity of the type of medication requested via the first medication request available to reserve for filling medication requests; and (3) after determining that the first medication filling device's inventory has the quantity of the type of medication requested via the first medication request available to reserve for filling medication requests, reserve, from the first medication filling device's inventory, the quantity of the type of medication requested via the first medication request.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is an overview of a system that can be used to practice various embodiments of the present invention.

FIG. 2 is an illustrative schematic diagram of a medication server according to one embodiment of the present invention.

FIG. 3 shows exemplary input/output that can be produced according to one embodiment of the present invention.

FIG. 4 is a flowchart illustrating operations and processes that can be used in accordance with various embodiments of the present invention.

### DETAILED DESCRIPTION

Various embodiments of the present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “exemplary” are used to be examples with no indication of quality level. Like numbers refer to like elements throughout.

### I. Methods, Apparatus, Systems, and Computer Program Products

As should be appreciated, various embodiments may be implemented in various ways, including as methods, apparatus, systems, or computer program products. Accordingly, various embodiments may take the form of an entirely hardware embodiment or an embodiment in which a processor is programmed to perform certain steps. Furthermore, various implementations may take the form of a computer program product on a computer-readable storage medium having computer-readable program instructions embodied in the storage medium. Any suitable computer-readable storage medium may be utilized including hard disks, CD-ROMs, optical storage devices, or magnetic storage devices.

Various embodiments are described below with reference to block diagrams and flowchart illustrations of methods, apparatus, systems, and computer program products. It should be understood that each block of the block diagrams and flowchart illustrations, respectively, may be implemented in part by computer program instructions, e.g., as logical steps or operations executing on a processor in a computing system. These computer program instructions may be loaded onto a computer, such as a special purpose computer or other programmable data processing apparatus to produce a specifically-configured machine, such that the instructions which execute on the computer or other programmable data processing apparatus implement the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the functionality specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide operations for implementing the functions specified in the flowchart block or blocks.

Accordingly, blocks of the block diagrams and flowchart illustrations support various combinations for performing the specified functions, combinations of operations for performing the specified functions and program instructions for performing the specified functions. It should also be understood that each block of the block diagrams and flowchart illustrations, and combinations of blocks in the block diagrams and flowchart illustrations, can be implemented by special purpose hardware-based computer systems that perform the specified functions or operations, or combinations of special purpose hardware and computer instructions.

### II. General Overview

In general, according to various embodiments of the present invention, methods, apparatus, systems, and computer program products are provided for medication inventory management. In one embodiment, a server can receive medication requests from various sources, such as doctors and units in hospitals. After receiving medication requests, the server can evaluate medication requests either individually or collectively and identify devices that have sufficient inventory to fill the requests. The server can then reserve medications in the appropriate devices and assign the medication requests accordingly. In various embodiments, these concepts can be used to prevent the assignment of medication requests to devices that will not be able to fill the requests.

### III. Exemplary System Architecture

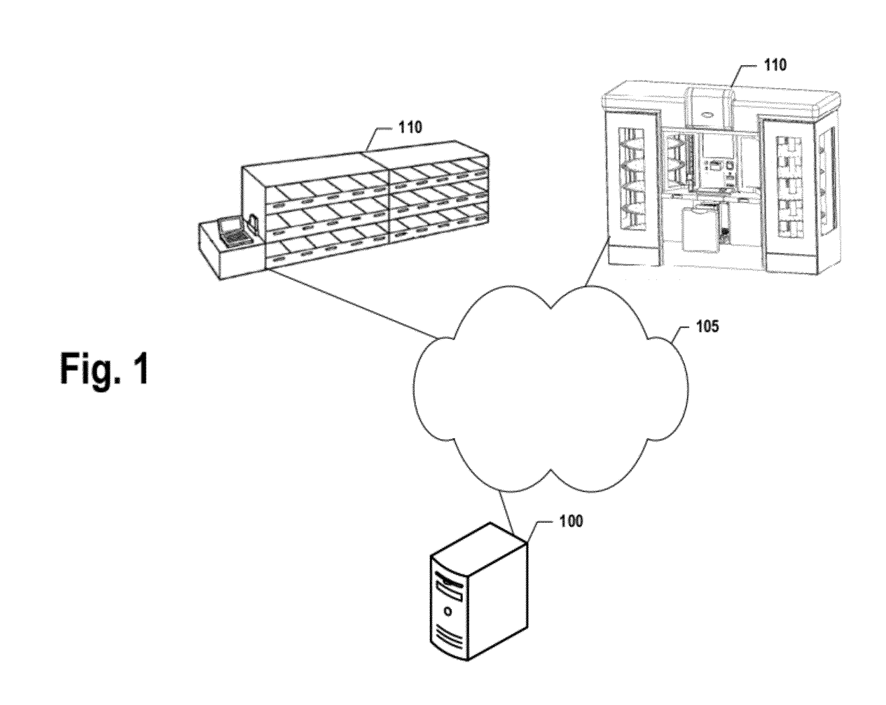

FIG. 1 provides an illustration of a system that can be used in conjunction with various embodiments of the present invention. As shown in FIG. 1, the system may include one or more medication servers 100, one or more networks 105, and/or one or more medication filling devices 110. Each of the components of the system may be in electronic communication with, for example, one another over the same or different wireless or wired networks including, for example, a wired or wireless Personal Area Network (“PAN”), Local Area Network (“LAN”), Metropolitan Area Network (“MAN”), Wide Area Network (“WAN”), or the like. Additionally, while FIG. 1 illustrates certain system entities as separate, standalone entities, the various embodiments are not limited to this particular architecture.

### 1. Exemplary Medication Server

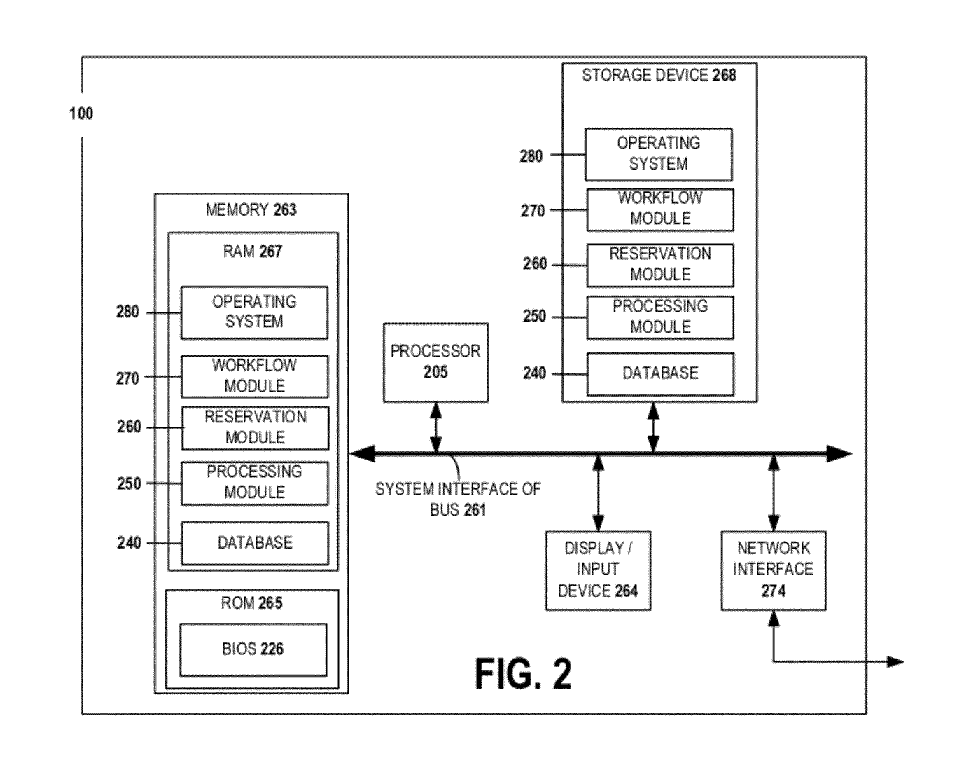

FIG. 2 provides a schematic of a medication server 100 according to one embodiment of the present invention. In general, the term “server” may refer to, for example, any computer, computing device, mobile phone, desktop, notebook or laptop, distributed system, server, blade, gateway, switch, processing device, or combination of processing devices adapted to perform the functions described herein. As will be understood from this figure, in one embodiment, the medication server 100 includes a processor 205 that communicates with other elements within the medication server 100 via a system interface or bus 261. The processor 205 may be embodied in a number of different ways. For example, the processor 205 may be embodied as a processing element, a coprocessor, a controller or various other processing devices including integrated circuits such as, for example, an application specific integrated circuit (“ASIC”), a field programmable gate array (“FPGA”), a hardware accelerator, or the like.

In an exemplary embodiment, the processor 205 may be configured to execute instructions stored in the device memory or otherwise accessible to the processor 205. As such, whether configured by hardware or software methods, or by a combination thereof, the processor 205 may represent an entity capable of performing operations according to embodiments of the present invention when configured accordingly. A display device/input device 264 for receiving and displaying data may also be included in the medication server 100. This display device/input device 264 may be, for example, a keyboard or pointing device that is used in combination with a monitor. The medication server 100 may further include transitory and non-transitory memory 263, which may include both random access memory (“RAM”) 267 and read only memory (“ROM”) 265. The medication server's ROM 265 may be used to store a basic input/output system (“BIOS”) 226 containing the basic routines that help to transfer information to the different elements within the medication server 100.

In addition, in one embodiment, the medication server 100 may include at least one storage device 268, such as a hard disk drive, a CD drive, and/or an optical disk drive for storing information on various computer-readable media. The storage device(s) 268 and its associated computer-readable media may provide nonvolatile storage. The computer-readable media described above could be replaced by any other type of computer-readable media, such as embedded or removable multimedia memory cards (“MMCs”), secure digital (“SD”) memory cards, Memory Sticks, electrically erasable programmable read-only memory (“EEPROM”), flash memory, hard disk, or the like. Additionally, each of these storage devices 268 may be connected to the system bus 261 by an appropriate interface.

Furthermore, a number of program modules may be stored by the various storage devices 268 and/or within RAM 267. Such program modules may include an operating system 280, a workflow module 270, a reservation module 260, and a processing module 250. As discussed in more detail below, these modules may control certain aspects of the operation of the medication server 100 with the assistance of the processor 205 and operating system 280—although their functionality need not be modularized. In addition to the program modules, the medication server 100 may store or be in communication with one or more databases (e.g., database 240).

Also located within the medication server 100, in one embodiment, is a network interface 274 for interfacing with various computing entities. This communication may be via the same or different wired or wireless networks (or a combination of wired and wireless networks), as discussed above. For instance, the communication may be executed using a wired data transmission protocol, such as fiber distributed data interface (“FDDI”), digital subscriber line (“DSL”), Ethernet, asynchronous transfer mode (“ATM”), frame relay, data over cable service interface specification (“DOCSIS”), or any other wired transmission protocol. Similarly, the medication server 100 may be configured to communicate via wireless external communication networks using any of a variety of protocols, such as 802.11, general packet radio service (“GPRS”), wideband code division multiple access (“W-CDMA”), Long Term Evolution (“LTE”), IEEE 802.11 (“Wi-Fi”), 802.16 (“WiMAX”), ultra wideband (“UWB”), and/or any other wireless protocol.

It will be appreciated that one or more of the medication server's 100 components may be located remotely from other medication server 100 components. Furthermore, one or more of the components may be combined and additional components performing functions described herein may be included in the medication server 100.

### 2. Exemplary Medication Filling Devices/Systems

As shown in FIG. 1, the system may include one or more medication filling devices 110. A medication filling device 110 may be a device, apparatus, robot, system, computer, and/or the like that can be used in filling medication requests. For example, a medication filling device 110 may be a ROBOT-Rx® automated medication dispensing system, MedCarousel® system, MedShelf system, IntelliShelf-Rx® system, PROmanager-Rx™ pharmacy automation system, PACMED™ high-speed packager, Satellite Replenishment system, Fulfill-Rx™ solution, and/or the like. Thus, as will be recognized, medication filling devices 110 may operated automatically, semi-automatically, and/or manually and include various components such as (1) processing elements, (2) memory, (3) network interfaces, (4) transceivers, (5) display devices/input devices, input and/or (6) various other components.

By way of example, in one embodiment, a pharmacist or pharmacy technician may use a MedCarousel® system or MedShelf system to manually pick medications to fill medication requests. For example, the MedShelf system may receive (from the medication server 100) and display medication requests that are assigned to a particular medication filling device 110, pharmacist, and/or pharmacy technician for filling. Using the MedShelf system, the pharmacist or pharmacy technician can manually fill the medication requests and enter input via the MedShelf system indicating that the medication requests have been filled.

In another embodiment, automated systems may facilitate the filling of medication requests. For example, ROBOT-Rx® is a stationary robotic system that automates the medication storing, dispensing, returning, restocking, and crediting process by using various technologies. Operatively, ROBOT-Rx® can receive medication requests from the medication server 100. At the appropriate time, ROBOT-Rx® can guide a picking mechanism to select the desired medications and deposit them in, for example, specific boxes or containers to fill a particular medication request. In response to (e.g., after) filling a medication request, ROBOT-Rx® can transmit a message to the medication server 100, for example, indicating that the medication request has been filled.

As will be recognized, a variety of approaches and techniques may be used for filling medication requests. Accordingly, the foregoing examples are provided for illustrative purposes only and should not be taken in any way as limiting embodiments of the present invention to the examples provided.

### IV. Exemplary System Operation

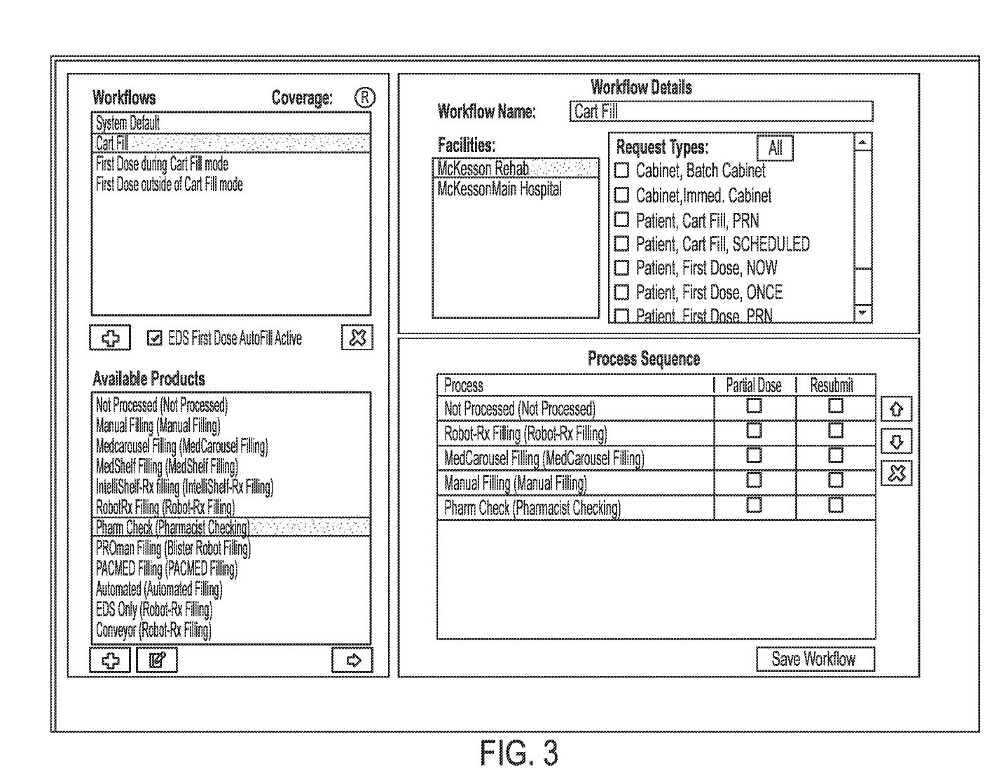

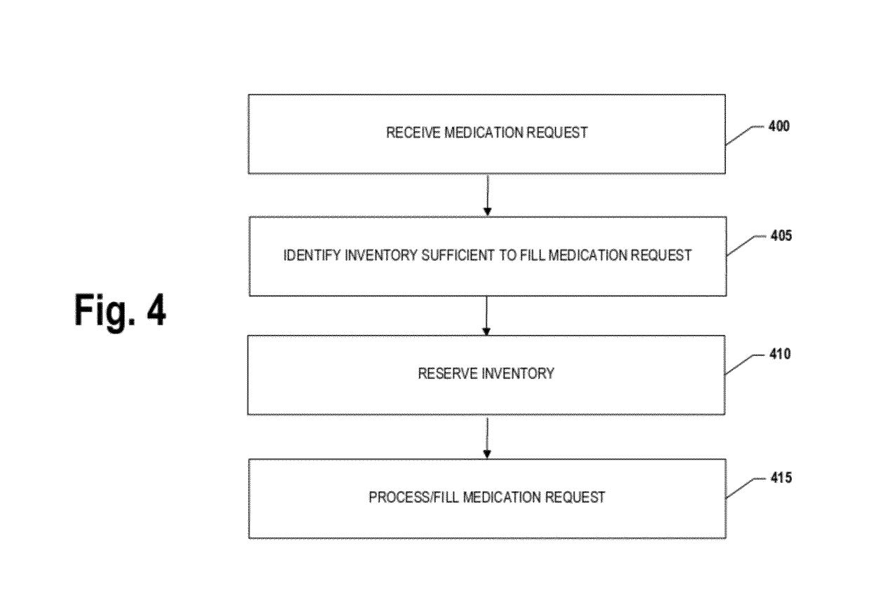

Reference will now be made to FIGS. 3-4. FIG. 3 shows exemplary input/output for medication inventory management. FIG. 4 is a flowchart illustrating operations and processes that can be used for medication inventory management.

### 1. Exemplary Medication Requests

In one embodiment, as indicated in Block 400 of FIG. 4, the medication server 100 can receive medication requests on a routine, periodic, and/or continuous basis from a variety of sources, such as doctors, patients, hospitals, pharmacies, departments or storage locations within health care facilities, and/or the like. Medication requests may be used to request certain quantities of one or more medications. To assist in processing medication requests, each medication request may include information, such as patient name, patient birth date, patient identification number, patient insurance information, patient allergies, patient location, medication request type, medication request priority, medication filling commit time, types of medications requested, quantities of each medication requested, and/or the like.

Medication requests may be used, for example, to fill prescriptions of patients or to transfer inventory from one location to another. For instance, the medication request type may be used to indicate that the medication request is a patient request or an inventory request. In one embodiment, patient requests may be cart-fill requests, first-dose requests, and/or the like. A cart-fill medication request may be used to indicate that the medication request is for a patient but is to be filled as part of a batch process of medication requests that, for example, are delivered daily to a hospital, unit in a hospital, and/or health care facility. A first-dose medication request may be used to indicate medication requests that are needed promptly, such as for newly admitted patients or when there is a change to a medication that was cart-filled.

In one embodiment, inventory requests may be cabinet refill requests, inventory transfer requests, packaging requests, and/or the like. A cabinet refill request may be used to indicate that the medication request is to refill a medication cabinet, for example, located at a nursing station within a health care facility. For example, when medication levels in a medication cabinet in a cardiovascular wing are low, a cabinet refill request may be generated to refill one or more medications in the cabinet. An inventory transfer request may be used to provide items to a storage location (e.g., restocking room), and a packaging request may be used to initiate the packaging of medications into unit dose packages. As will be recognized, a variety of other approaches and techniques can be used to adapt to various needs and circumstances.

### 2. Exemplary Workflows

In one embodiment, medication requests can be processed in accordance with one or more workflows (e.g., via the workflow module 270). Workflows may define, for example, how medication requests (or certain types of medication requests) should be processed. For instance, as shown in FIG. 3, a workflow may be used to identify which medication filling devices 110 should be used with the workflow (e.g., any number of devices can be grouped together). For example, a workflow may define (and/or identify) that three ROBOT-Rx® devices (e.g., a first ROBOT-Rx® device, a second ROBOT-Rx® device, and a third ROBOT-Rx® device) can be used simultaneously to fill medication requests. Workflows may also define (and/or identify) that the ROBOT-Rx® devices should be used in a specific order. For example, a workflow may define (and/or identify) that the first ROBOT-Rx® device should be the first device considered for filling a medication request, followed by the second ROBOT-Rx® device, and then followed by the third ROBOT-Rx® device. In another embodiment, a workflow may define (and/or identify) a round-robin approach for considering the three medication filling devices 110 for filling medication requests. In that regard, a variety of approaches and techniques can be used to adapt to various needs and circumstances.

In one embodiment, workflows may also define the types of medication requests that should be processed and the order and manner in which the medication requests should proceed (if necessary) to the different medication filling devices 110, such as the order in which medication requests for certain facilities should be processed. For example, medication requests from a main hospital may have priority over medication requests from a rehab center. Similarly, patient requests may have priority over inventory requests. Workflows can also be used to define other processing steps/procedures for filling medication requests and various entry states and possible exit states for each workflow. For example, workflows can define how filled and partially-filled medication requests should be checked for accuracy and completed. As will be recognized, a variety of other approaches and techniques can be used to adapt to various needs and circumstances.

### 3. Exemplary Reservations

In one embodiment, the medication server 100 may routinely, periodically, and/or continuously track/monitor the progress of medication requests and indicate/update the status of each medication request. For example, an unassigned medication request may refer to a medication request that has been received by the medication server 100 but not assigned to a medication filling device 110 for filling. Similarly, an assigned medication request may refer to a medication request that has been received by the medication server 100 and assigned to a particular medication filling device 110 for filling, but has not yet been filled. Once a medication request has been filled, the medication request may be referred to as a filled or completed medication request. Other potential statuses associated with medication requests may include partially filled, checked, verified, returned, wasted, delivered, retrieved, packaged, shipped, and/or the like. Moreover, more than one status may be associated with a medication request. For example, a medication request may be both assigned and partially filled.

In one embodiment, the medication server 100 may also routinely, periodically, and/or continuously track/monitor/update the medication inventory of the respective medication filling devices 110. This may include tracking/monitoring/updating the types of medication in each medication filling device 110 and the quantities of each type of medication (both reserved quantities and unreserved quantities). Reserved medication inventory may refer to medication (quantities of one or more types of medication) that has been allocated to fill one or more medication requests assigned to a medication filling device 110. Similarly, unreserved medication inventory may refer to medication that has not yet been allocated to fill one or more medication requests.

In one embodiment, after receiving one or more medication requests, the medication server 100 may evaluate an unassigned medication request individually. In another embodiment, the medication server 100 may evaluate multiple unassigned medication requests collectively. Evaluating a medication request may include identifying/determining the types and quantities of medications requested in the medication request. For example, the medication server 100 may select a first medication request in queue and determine that the first medication request is for 15 acetaminophen tablets and has a medication request priority of 3. In another example, the medication server 100 may select the first 7 unassigned medication requests in queue and determine that collectively the requests are for 72 acetaminophen tablets.

In one embodiment, after (before, or simultaneously to) evaluating the unassigned medication request(s), the medication server 100 may identify/determine which medication filling device(s) should be used to fill the unassigned medication request. For instance, a workflow may define (and/or identify) that three ROBOT-Rx® devices (e.g., a first ROBOT-Rx® device, a second ROBOT-Rx® device, and a third ROBOT-Rx® device) can be used simultaneously to fill medication requests. As previously described, the workflow may also define (and/or identify) that the ROBOT-Rx® devices should be used in a specific order. In this example, the workflow may define that the first ROBOT-Rx® device should be the first device considered for filling a medication request, followed by the second ROBOT-Rx® device, and then followed by the third ROBOT-Rx® device.

After evaluating the unassigned medication request(s) and identifying/determining which medication filling device(s) 100 should be used, the medication server 100 may determine whether the appropriate medication filling device's inventory has both the requested type(s) of medication and the requested quantity of the medication(s) available to reserve for filling the unassigned medication request(s) (Block 405 of FIG. 4). The above example assumes the first ROBOT-Rx® device has 67 unreserved acetaminophen tablets, the second ROBOT-Rx® device has 98 unreserved acetaminophen tablets, and the third ROBOT-Rx® device has 85 unreserved acetaminophen tablets. Thus, in this example, the medication server 100 may determine that the first ROBOT-Rx® device's inventory has sufficient unreserved acetaminophen tablets (e.g., 67 unreserved tablets) to fill the first medication request (e.g., 15 tablets).

As indicated in Block 410 of FIG. 4, in response to (e.g., after) determining that the appropriate medication filling device's inventory has both the requested type(s) of medication and the requested quantity of the medication(s) available to reserve for filling the unassigned medication request(s), the medication server 100 may reserve the medication in the appropriate device's medication inventory (e.g., via the reservation module 260). Reserving medication may include decrementing the appropriate medication filling device's inventory available to reserve for filling the unassigned medication request(s) based at least in part on the unassigned medication request(s). In addition to reserving the appropriate available inventory, the medication server 100 may also assign the unassigned medication request(s) to the appropriate medication filling device 110 for filling. Assigning a medication request may include transmitting the medication request to the medication filing device 110 and updating the medication request's status. Continuing with the above example, the medication server 100 may reserve 15 of the 67 unreserved acetaminophen tablets in the first ROBOT-Rx® device's inventory—leaving a balance of 52 unreserved acetaminophen tablets—and assign the first medication request to the first ROBOT-Rx® device for filling. As will be recognized, similar processes can be repeated for any number of unassigned medication requests (either individually or collectively). In various embodiments, these concepts may ensure that the medication filling devices 110 to which medication requests are assigned have sufficient medication inventory available for filling the unassigned medication request(s).

However, if a medication filling device's 100 inventory does not have both the requested type(s) of medication and the requested quantity of the medication(s) available to reserve for filling the unassigned medication request(s), the medication server 100 may use various approaches to fill the unassigned medication request(s). For example, in one embodiment, in response to (e.g., after) determining that the appropriate medication filling device's inventory does not have the requested quantity of the medication(s) available to reserve for filling the unassigned medication request(s), the medication server 100 may determine whether another medication filling device 110 can be used to fill the request(s). For instance, after assigning the first medication request to the first ROBOT-Rx® device, the medication server 100 may evaluate a second unassigned medication request for 55 acetaminophen tablets with medication request priority of 1. Thus, in this example, the medication server 100 may determine that the first ROBOT-Rx® device does not have sufficient unreserved acetaminophen tablets available to reserve for filling the second medication request as the first ROBOT-Rx® device has 52 unreserved acetaminophen tablets. Correspondingly, the medication server 100 may then determine whether the second ROBOT-Rx® device has sufficient unreserved acetaminophen tablets to fill the second medication request. In this example, the second ROBOT-Rx® device has sufficient unreserved medication in its inventory (e.g., 98 unreserved acetaminophen tablets) to fill the second medication request (e.g., 55 acetaminophen tablets and a medication request priority of 1). Accordingly, after making this determination, the medication server 100 may reserve the 55 of the 98 unreserved acetaminophen tablets in the second ROBOT-Rx® device—leaving a balance of 43 unreserved acetaminophen tablets in the second ROBOT-Rx® device. The medication server 100 may also assign the second medication request to the second ROBOT-Rx® device for filling.

In another embodiment, in response to (e.g., after) determining that the appropriate medication filling device's inventory does not have the requested quantity of the medication(s) available to reserve for filling the unassigned medication request(s), the medication server 100 may determine whether the unassigned medication request(s) has a higher medication request priority than one or more medication request(s) assigned to a medication filling device 110 under consideration. In one embodiment, if an unassigned medication request has a higher medication request priority than an assigned medication request, the medication server 100 may cancel the assigned medication request, transfer the assigned medication request to another device, and/or unassign the assigned medication request and return it to the queue for processing (and update its status accordingly). Such actions may be dependent upon whether canceling, transferring, and/or unassigning the assigned medication request would allow for the unassigned medication request to be filled on the medication filling device 110 under consideration.

Continuing with the above example, after assigning the first medication request to the first ROBOT-Rx® device, the medication server 100 may evaluate a second unassigned medication request for 55 acetaminophen tablets with a medication request priority of 1. Thus, in this example, the medication server 100 may determine that the first ROBOT-Rx® device does not have sufficient unreserved acetaminophen tablets available to reserve for filling the second medication request—as the first ROBOT-Rx® device has a balance of 52 unreserved tablets. At this point, the medication server 100 may then determine whether the second medication request has a higher medication request priority than the first medication request. As indicated, in this example, the second medication request (for 55 acetaminophen tablets) has a medication request priority of 1 and the first medication request has a medication request priority of 3. Accordingly, the medication server 100 may determine that the second medication request has a higher medication request priority than the first medication request. Thus, as one of many approaches, the medication server 100 may unassign the first medication request from the first ROBOT-Rx® device given that the second medication request could be filled by the first ROBOT-Rx® device if the first medication request were unassigned. As previously described, unassigning a medication request may include releasing/canceling the reservation for the corresponding request, which may increment the appropriate medication filling device's inventory that is available to reserve for filling medication request(s). In this example, unassigning the first medication request from the first ROBOT-Rx® device may release/cancel the reservation for the first medication request's 15 acetaminophen tablets. As a result, the first ROBOT-Rx® device would again have 67 unreserved acetaminophen tablets. The medication server 100 may then reserve 55 of the 67 unreserved acetaminophen tablets in the first ROBOT-Rx® device for the second medication request—leaving a balance of 12 unreserved acetaminophen tablets in the first ROBOT-Rx® device. The medication server 100 may also assign the second medication request to the first ROBOT-Rx® device for filling. Additionally, the medication server 100 may transfer the first medication request to another medication filling device 110, return the first medication request to the queue for processing as an unassigned medication request, and/or the like.

In various embodiments, these concepts may be used to prevent assigning medication requests to medication filling devices 110 that will not be able to fill the requests, for example, based on their medication inventory. As will be recognized, though, a variety of other approaches and techniques can be used to adapt to various needs and circumstances.

### 4. Exemplary Processing

In one embodiment, as indicated in Block 415 of FIG. 4, medication requests can be processed and filled by the appropriate medication filling devices 110 (e.g., via the processing module 250). For example, the medication server 100 may transmit medication requests to the first ROBOT-Rx® device for filling. As part of the process, a pharmacy technician can view the assigned medication requests via a display (e.g., a dashboard) disposed on or adjacent the first ROBOT-Rx® device. The pharmacy technician can then print out labels and affix them to bins (and/or boxes or bags) and place the bins on a conveyer, for example. Each time a bin is moved into the scan position, the first ROBOT-Rx® device can scan the corresponding label and pick the medications associated with the assigned medication request. After the medications associated with the assigned medication request (e.g., a third assigned medication request) have been picked, the medications may be checked for accuracy and packaged in accordance with the appropriate workflow. If accurately and completely filled, the first ROBOT-Rx® (or other appropriate device) can transmit an indication to the medication server 100 that the assigned medication request (e.g., the third assigned medication request) has been filled. The medication server 100 can then update the status of the third assigned medication request (and its records) to reflect the filling. For example, the status of the third assigned medication request may be changed to filled, which may unassign the third assigned medication request from the first ROBOT-Rx® device.

In another example, a pharmacy technician can view the third assigned medication request via a display (e.g., a dashboard) disposed on or adjacent a MedCarousel® system. The pharmacy technician can then print out a label and affix it to a box, bag, or envelope and scan the label. After the label is scanned, the MedCarousel® system can be used to fill the third assigned medication request. Once the third assigned medication request is accurately and completely filled, a pharmacist or pharmacy technician can enter input via the MedCarousel® system indicating that the third assigned medication request has been filled. The input can then be transmitted to the medication server 100. The medication server 100 can then update the status of the third assigned medication request (and its records) to reflect the filling. For example, the status of the third assigned medication request may be changed to filled, which may unassign the third assigned medication request from the MedCarousel® system.

As will be recognized, the described examples are provided only for illustrative purposes and should not be taken in any way as limiting embodiments of the present invention to the examples provided. Thus, as will be recognized, a variety of other approaches and techniques may be used.

### V. Conclusion

And as will be recognized, many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. A method for medication inventory management, the method comprising:
identifying, via one or more processors, a first medication request that identifies (a) a type of medication requested and (b) a quantity of the medication requested;
determining, via the one or more processors, whether a first medication filling device's inventory has the quantity of the type of medication requested via the first medication request available to reserve for filling medication requests; and
after determining that the first medication filling device's inventory has the quantity of the type of medication requested via the first medication request available to reserve for filling medication requests, reserving, from the first medication filling device's inventory, the quantity of the type of medication requested via the first medication request.

2. The method of claim 1, wherein (a) each of the plurality of medication requests is associated with a priority and (b) reserving comprises decrementing the first medication filling device's available inventory by the quantity of the type of medication requested via the first medication request.

3. The method of claim 2 further comprising:
identifying, via one or more processors, a second medication request that identifies (a) a type of medication requested and (b) a quantity of the medication requested, wherein the type of medication requested via the first medication request and the type of medication requested via the second medication request are substantially similar;
determining, via the one or more processors, whether the first medication filling device's inventory has the quantity of the type of medication requested via the second medication request available to reserve for filling medication requests; and
after determining that the first medication filling device's inventory does not have the quantity of the type of medication requested via the second medication request available to reserve for filling medication requests, identifying (a) the priority of the first medication request and (b) the priority of the second medication request.

4. The method of claim 3 further comprising:
determining whether the priority of the second medication request is higher than the priority of the first medication request;
after determining that the priority of the second medication request is higher than the priority of the first medication request, canceling the reservation for the first medication request, wherein canceling the reservation comprises incrementing the first medication filling device's available inventory by the quantity of the type of medication requested via the first medication request; and
reserving, from the first medication filling device's inventory, the quantity of the type of medication requested via the second medication request.

5. The method of claim 4 further comprising filling the second medication request at least in part by the first medication filling device.

6. The method of claim 1 further comprising:
identifying, via one or more processors, a second medication request that identifies (a) a type of medication requested and (b) a quantity of the medication requested;
determining, via the one or more processors, whether the first medication filling device's inventory has the quantity of the type of medication requested via the second medication request available to reserve for filling medication requests;
after determining that the first medication filling device's inventory does not have the quantity of the type of medication requested via the second medication request available to reserve for filling medication requests, determining whether a second medication filling device's inventory has the quantity of the type of medication requested via the second medication request available to reserve for filling medication requests; and
after determining that the second medication filling device's inventory has the quantity of the type of medication requested via the second medication request available to reserve for filling medication requests, reserving, from the second medication filling device's inventory, the quantity of the type of medication requested via the second medication request.

7. The method of claim 1 further comprising:
identifying, via one or more processors, a second medication request that identifies (a) a type of medication requested and (b) a quantity of the medication requested;
determining, via the one or more processors, whether the first medication filling device's inventory has the quantity of the type of medication requested via the second medication request available to reserve for filling medication requests; and
after determining that the first medication filling device's inventory has the quantity of the type of medication requested via the second medication request available to reserve for filling medication requests, reserving, from the first medication filling device's inventory, the quantity of the type of medication requested via the second medication request.

8. A computer program product for medication inventory management, the computer program product comprising at least one computer-readable storage medium having computer-readable program code portions stored therein, the computer-readable program code portions comprising:
an executable portion configured to identify a first medication request that identifies (a) a type of medication requested and (b) a quantity of the medication requested;
an executable portion configured to determine whether a first medication filling device's inventory has the quantity of the type of medication requested via the first medication request available to reserve for filling medication requests; and
an executable portion configured to, after determining that the first medication filling device's inventory has the quantity of the type of medication requested via the first medication request available to reserve for filling medication requests, reserve, from the first medication filling device's inventory, the quantity of the type of medication requested via the first medication request.

9. The computer program product of claim 8, wherein (a) each of the plurality of medication requests is associated with a priority and (b) reserving comprises decrementing the first medication filling device's available inventory by the quantity of the type of medication requested via the first medication request.

10. The computer program product of claim 9 further comprising:
an executable portion configured to identify a second medication request that identifies (a) a type of medication requested and (b) a quantity of the medication requested, wherein the type of medication requested via the first medication request and the type of medication requested via the second medication request are substantially similar;
an executable portion configured to determine whether the first medication filling device's inventory has the quantity of the type of medication requested via the second medication request available to reserve for filling medication requests; and
an executable portion configured to, after determining that the first medication filling device's inventory does not have the quantity of the type of medication requested via the second medication request available to reserve for filling medication requests, identify (a) the priority of the first medication request and (b) the priority of the second medication request.

11. The computer program product of claim 10 further comprising:
an executable portion configured to determine whether the priority of the second medication request is higher than the priority of the first medication request;
an executable portion configured to, after determining that the priority of the second medication request is higher than the priority of the first medication request, cancel the reservation for the first medication request, wherein canceling the reservation comprises incrementing the first medication filling device's available inventory by the quantity of the type of medication requested via the first medication request; and
an executable portion configured to, reserve, from the first medication filling device's inventory, the quantity of the type of medication requested via the second medication request.

12. The computer program product of claim 8 further comprising:
an executable portion configured to identify a second medication request that identifies (a) a type of medication requested and (b) a quantity of the medication requested;
an executable portion configured to determine whether the first medication filling device's inventory has the quantity of the type of medication requested via the second medication request available to reserve for filling medication requests;
an executable portion configured to, after determining that the first medication filling device's inventory does not have the quantity of the type of medication requested via the second medication request available to reserve for filling medication requests, determine whether a second medication filling device's inventory has the quantity of the type of medication requested via the second medication request available to reserve for filling medication requests; and
an executable portion configured to, after determining that the second medication filling device's inventory has the quantity of the type of medication requested via the second medication request available to reserve for filling medication requests, reserve, from the second medication filling device's inventory, the quantity of the type of medication requested via the second medication request.

13. The computer program product of claim 8 further comprising:
an executable portion configured to identify a second medication request that identifies (a) a type of medication requested and (b) a quantity of the medication requested;
an executable portion configured to determine whether the first medication filling device's inventory has the quantity of the type of medication requested via the second medication request available to reserve for filling medication requests; and
an executable portion configured to, after determining that the first medication filling device's inventory has the quantity of the type of medication requested via the second medication request available to reserve for filling medication requests, reserve, from the first medication filling device's inventory, the quantity of the type of medication requested via the second medication request.

14. An apparatus comprising at least one processor and at least one memory including computer program code, the at least one memory and the computer program code configured to, with the processor, cause the apparatus to at least:
identify a first medication request that identifies (a) a type of medication requested and (b) a quantity of the medication requested;
determine whether a first medication filling device's inventory has the quantity of the type of medication requested via the first medication request available to reserve for filling medication requests; and
after determining that the first medication filling device's inventory has the quantity of the type of medication requested via the first medication request available to reserve for filling medication requests, reserve, from the first medication filling device's inventory, the quantity of the type of medication requested via the first medication request.

15. The apparatus of claim 14, wherein (a) each of the plurality of medication requests is associated with a priority and (b) reserving comprises decrementing the first medication filling device's available inventory by the quantity of the type of medication requested via the first medication request.

16. The apparatus of claim 15, wherein the memory and computer program code are further configured to, with the processor, cause the apparatus to:
identify a second medication request that identifies (a) a type of medication requested and (b) a quantity of the medication requested, wherein the type of medication requested via the first medication request and the type of medication requested via the second medication request are substantially similar;
determine whether the first medication filling device's inventory has the quantity of the type of medication requested via the second medication request available to reserve for filling medication requests; and
after determining that the first medication filling device's inventory does not have the quantity of the type of medication requested via the second medication request available to reserve for filling medication requests, identify (a) the priority of the first medication request and (b) the priority of the second medication request.

17. The apparatus of claim 16, wherein the memory and computer program code are further configured to, with the processor, cause the apparatus to:
determine whether the priority of the second medication request is higher than the priority of the first medication request;
after determining that the priority of the second medication request is higher than the priority of the first medication request, cancel the reservation for the first medication request, wherein canceling the reservation comprises incrementing the first medication filling device's available inventory by the quantity of the type of medication requested via the first medication request; and
reserve, from the first medication filling device's inventory, the quantity of the type of medication requested via the second medication request.

18. The apparatus of claim 14, wherein the memory and computer program code are further configured to, with the processor, cause the apparatus to:
identify a second medication request that identifies (a) a type of medication requested and (b) a quantity of the medication requested;
determine whether the first medication filling device's inventory has the quantity of the type of medication requested via the second medication request available to reserve for filling medication requests;
after determining that the first medication filling device's inventory does not have the quantity of the type of medication requested via the second medication request available to reserve for filling medication requests, determine whether a second medication filling device's inventory has the quantity of the type of medication requested via the second medication request available to reserve for filling medication requests; and
after determining that the second medication filling device's inventory has the quantity of the type of medication requested via the second medication request available to reserve for filling medication requests, reserve, from the second medication filling device's inventory, the quantity of the type of medication requested via the second medication request.

19. The apparatus of claim 14, wherein the memory and computer program code are further configured to, with the processor, cause the apparatus to:
identify a second medication request that identifies (a) a type of medication requested and (b) a quantity of the medication requested;
determine whether the first medication filling device's inventory has the quantity of the type of medication requested via the second medication request available to reserve for filling medication requests; and
after determining that the first medication filling device's inventory has the quantity of the type of medication requested via the second medication request available to reserve for filling medication requests, reserve, from the first medication filling device's inventory, the quantity of the type of medication requested via the second medication request.
